(19) United States
(12) Patent Application Publication
(10) Pub. No.: US 2007/0172001 A1
(43) Pub. Date: Jul. 26, 2007

(54) DEMODULATION CIRCUIT AND DEMODULATION METHOD

(75) Inventors: Tatsuaki Kitta, Kawasaki (JP); Takanori Iwamatsu, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED, Kawasaki (JP)

(21) Appl. No.: 11/382,490

(22) Filed: May 10, 2006

(30) Foreign Application Priority Data
Jan. 20, 2006 (JP) 2006-013212

(51) Int. Cl. H04L 27/00; H04B 1/10

(52) U.S. Cl. 375/326; 375/350

(57) ABSTRACT

A demodulation circuit according to the present invention comprises an automatic equalizer for carrying out equalization processing of a signal, a carrier recovery circuit for carrying out carrier recovery processing based on an equalized signal by the automatic equalizer. A center tap for carrying out an amplitude control of the automatic equalizer is placed on an input side thereof, and a control signal to the center tap is transmitted from the automatic equalizer.

### CROSS-REFERENCE TO RELATED APPLICATIONS

This application is based upon and claims the benefit of priority from the prior Japanese Patent Application No. 2006-013212 filed on Jan. 20, 2006, the entire contents of which are incorporated herein by reference.

### BACKGROUND OF THE INVENTION

1. Field of the Invention

The present invention relates to a demodulation circuit and a demodulation method, and in particular to a demodulation circuit and a demodulation method which enable a compact circuit size while securing an accuracy of an amplitude control.

2. Description of the Related Art

One of systems for modulating data at transmission is a Quadrature Amplitude Modulation (QAM) system. This modulation system is one to make 2ⁿ signal points on an IQ phase plane (i.e., a plane consisting of an I channel signal as the horizontal axis and a Q channel signal as the vertical axis) correspond to 2ⁿ signs. A transmission side obtains an I channel signal and a Q channel signal by multiplying a carrier wave with a carried wave which are mutually orthogonal and transmits a signal by adding the aforementioned two signals.

FIG. 1 is a block diagram showing a configuration of a QAM receiver (i.e., a QAM demodulation circuit) according to a first conventional technique.

Referring to FIG. 1, a tuned-in signal, i.e., IFᵢₙ, by a tuner (not shown herein) at the previous stage is input to a variable gain amplifier (VGA) 11.

The signal IFᵢₙ is amplified by way of the VGA 11 and converted from an analog signal to a digital signal by way of an A/D (analog to digital) converter 12.

A signal output from the A/D converter 12 is branched into a signal headed for an AGC (automatic gain control) circuit 13 and one headed for mixers 14₁ and 14₂.

The output of the A/D converter 12 headed for the AGC circuit 13 is evaluated thereby for its power, and a gain control signal is output to the VGA 11. That is, an automatic gain control (AGC) loop is constituted by the VGA 11, A/D converter 12 and AGC circuit 13. Note that an input to the A/D converter 12 is controlled for the AGC loop so as to make the power constant and therefore it is also called a power control loop.

Meanwhile, the output of the A/D converter 12 headed for the mixers 14₁ and 14₂ are multiplied by mutually orthogonal sine waves respectively indicated by Cos (ωt) and Sin(ωt) at the mixers 14₁ and 14₂, thereby being branched into the I channel and Q channel signals and also down-converted to a base band.

Channel selection filters (low pass filters) 15₁ and 15₂ remove respectively an upper signal generated by the down-conversion and also an adjacent channel (signal) of the signal.

The outputs of the channel selection filters 15₁ and 15₂ are gain-controlled by a digital AGC loop constituted by mixers 86₁ and 86₂ and a digital AGC circuit 87. An equipment of the digital AGC loop suppresses an input dynamic range of interpolators 17₁ and 17₂, thereby preventing the circuit size from becoming large.

The outputs of the mixers 86₁ and 86₂ are gain-controlled by the digital AGC loop and are input to the interpolators 17₁ and 17₂.

The interpolators 17₁ and 17₂ generate data values at a clock time displaced from an input data clock time by interpolation based on a tap coefficient received from a tap table 33. Thin-out units 18, and 182 thin out duplicated points from outputs of the interpolators 17₁ and 17₂.

The outputs of the thin-out units 18₁ and 18₂ are applied by a band limitation by way of Root Nyquist filters (low pass filters) 21₁ and 21₂, and thereby a white noise and a nearby adjacent channel are removed.

The outputs of the Root Nyquist filters 21₁ and 21₂ are input to an automatic equalizer unit. The automatic equalizer unit comprises a front automatic equalizer 88, a carrier recovery rotor (CR rotor) 23 and a rear automatic equalizer 24.

FIG. 2 shows a detail of a main part of the automatic equalizer unit shown by FIG. 1. The I channel and Q channel are respectively equipped with the automatic equalizer units shown by FIG. 2. A data equalization processing at the automatic equalizer unit removes an interference wave from data at the current clock time.

The automatic equalizer unit shown by FIG. 2 is a finite impulse response (FIR) filter having a tap coefficient operation function. Delay devices 36₂ through 36₅ show delay devices for the FIR filter. Discriminators 38₁ through 38₅, delay devices 41₁ through 41₅, mixers 42₁ through 42₅, integrators 43₁ through 43₅ and an error signal calculation unit 45 constitute a tap coefficient operation unit.

The automatic equalizer unit shown by FIG. 2 is the one comprising five stages capable of setting five tap coefficients. These five tap coefficients are set for mixers 35₁, 35₂, 35₃, 35₄ and 35₅ respectively. The mixer 35₃ is a tap (i.e., a center tap) for which a tap coefficient for data of the current clock time (i.e., the clock time t) is set. The mixer 35₁ is a tap for which a tap coefficient for data of the second newer clock time (i.e., the clock time t−2) than the current clock time is set. The mixer 35₂ is a tap for which a tap coefficient for data of the first newer clock time (i.e., the clock time t−1) than the current clock time is set. The mixer 35₄ is a tap for which a tap coefficient for data of the first older clock time (i.e., the clock time t+1) than the current clock time is set. The mixer 35₅ is a tap for which a tap coefficient for data of the second older clock time (i.e., the clock time t+2) than the current clock time is set.

The discriminators 38₁ through 38₅ are input by sampling data at corresponding respective clock times and calculate, and output, factors for multiplying with an error signal output from an error signal calculation unit 45 according to a sign (i.e., positive or negative) of the input sampling data (i.e., data of I channel or Q channel).

The factors output from the discriminators 38₁ through 38₅ are multiplied by an error signal from the error signal calculation unit 45 at the mixers 42₁ through 42₅. That is, error signals considering signs of data at the corresponding respective clock times are output from the mixers 42₁ through 42₅. Note that the delay devices 41₁ through 41₅ read out outputs of the latched discriminators 38₁ through 38₅ to the mixers 42₁ through 42₅ so that the multiplication at the mixers 42₁ through 42₅ are carried out at the right timing.

The error signals output from the mixers 42₁ through 42₅ are respectively integrated at integrators 43₁ through 43₅ and tap coefficients at the respective clock times are obtained. The tap coefficient of the current clock time, that is, the output of the integrator 43₃, is output to the center tap (mixer) 35₃. The tap coefficients of the respective clock times, that is, the output of the integrators 43₁ through 43₅ are multiplied by signals of the corresponding respective clock times at the taps (i.e., mixers) 35₁ through 35₅ and then output to an adder 34.

The adder 34 outputs a signal EQ_{OUT} by adding outputs of the mixers (i.e., taps) 35₁ through 35₅. The error signal calculation unit 45 acquires the difference between the signal EQ_{OUT} and a target signal (i.e., an I component or a Q component of the ideal signal point near to the data of the current clock time; in the case of 16 QAM, +2, +1, −1, and −2 make target signals for example), and outputs the difference as the error signal to the mixers 42₁ through 42₅.

Now the description of FIG. 1 is resumed.

A signal which an interference wave thereof is removed from and equalized by an automatic equalizer, that is, the output of the rear automatic equalizer 24, is branched into a signal progressing to a further later stage, one going to a carrier recovery circuit 25 and one going to a timing recovery circuit 31.

The carrier recovery circuit 25 calculates a phase displacement between a signal of the current clock time and an ideal signal point close to the aforementioned signal on the IQ phase plane based on the output of the rear automatic equalizer 24 and outputs a value reflected by the phase displacement to a numerical control oscillator (NCO) 26. The NCO 26 generates a saw-tooth wave with the amplitude of the value reflected by the phase displacement and outputs it to a Sin/Cos table 27. The Sin/Cos table 27 maps the amplitude of the input saw-tooth wave to one cycle of the phase angle (−π to π) and calculates values of sine and cosine relative to the phase angle corresponding to the amplitude of the input saw-tooth wave. The calculated sine and cosine values are output to the carrier recovery rotor 23 which then uses the calculated sine and cosine values, and applies a primary conversion, thereby rotating the signal of the current clock time on the IQ phase plane. Note that the rear automatic equalizer shown by FIG. 2 uses the data processed for rotation by the carrier recovery rotor 23 as the data of each clock time, as is apparent by way of the above description.

Meanwhile, the timing recovery circuit 31 calculates a temporal increase or decrease (i.e., a timing error) of a signal nearby a signal of the current clock time based on the output of the rear automatic equalizer 24, and outputs a value reflected by the temporal increase or decrease (i.e., the timing error) of the signal to a numerical control oscillator (NCO) 32. The NCO 32 generates a saw-tooth wave having the amplitude of the value reflected by the temporal increase or decrease (i.e., a timing error) of the signal. The saw-tooth wave generated by the NCO 32 is output to the tap table 33 and thin-out units 18, and 182. The tap table 33 maps the amplitude of the input saw-tooth wave in one cycle of the phase angle (−π to π) and calculates (a plurality of) tap coefficients of phase angles Δθ corresponding to the amplitude of the input saw-tooth wave.

The calculated tap coefficients are output to the interpolators (i.e., FIR filters) 17₁ and 17₂ which then acquire values of data at a displaced time from the clock time of the input data by interpolation based on the input data and the input (plurality of) tap coefficients. The output of the interpolators 17₁ and 17₂ are respectively input to the thin-out units 18₁ and 18₂.

The thin-out units 18₁ and 18₂ generate thin-out clocks based on the saw-tooth wave from the NCO 32 and read out data latched by the thin-out clocks to later stages, thereby thinning out duplicated points from the signals transmitted from the interpolators 17₁ and 17₂.

FIG. 3 is a block diagram showing a configuration of a QAM receiver (i.e., a QAM demodulation circuit) according to a second conventional technique. In contrast to FIG. 1 in which the digital AGC circuit 87 inputs signals from the mixers 86₁ and 86₂, a digital AGC circuit 91 inputs a signal from a rear automatic equalizer 24 and outputs it to mixers 86₁ and 86₂ in FIG. 3, which is the difference between FIG. 1 and FIG. 3.

FIG. 4 is a block diagram showing a configuration of a QAM receiver (i.e., a QAM demodulation circuit) according to a third conventional technique.

In FIG. 4, there are no interpolators 17₁ and 17₂, thin-out units 18₁ and 18₂, Root Nyquist filters 21₁ and 21₂, NCO 32 or tap table 33; and the output of a timing recovery circuit 31 is input to an A/D converter 85 as compared with FIG. 1.

That is, a D/A (digital to analog) converter 83 for converting an output of the timing recovery circuit 31 from the digital to analog and a voltage controlled oscillator (VCO) 84 for outputting, to an A/D converter 85, a frequency corresponding to the output of the timing recovery circuit 31 which is converted into the analog are inserted between the timing recovery circuit 31 and the A/D converter 85 in the configuration shown by FIG. 4.

FIG. 5 is a block diagram showing a configuration of a QAM receiver (i.e., a QAM demodulation circuit) according to a fourth conventional technique. In contrast to FIG. 4 in which the digital AGC circuit 87 inputs signals from the mixers 86₁ and 86₂, a digital AGC circuit 91 inputs a signal from a rear automatic equalizer 24 and outputs it to mixers 86₁ and 86₂ in FIG. 5, which is the difference between FIG. 4 and FIG. 5.

The circuits shown by FIGS. 3, 4 and 5 can be configured as modified examples of the QAM demodulation circuit shown by FIG. 1.

Incidentally, a symbol timing recovery technique using an interpolator, et cetera, is disclosed by a patent document 1.

[Patent document 1] Japanese registered patent No. 3573627; “Multi-rate symbol timing recovery circuit”

In the first conventional technique shown by FIG. 1, the digital AGC loop carries out a gain control by a signal prior to a timing recovery. Due to this, a gain control is conceivably possible by the digital AGC circuit 87, for example, temporally averaging an ample number of data. This case, however, is faced with a problem of degrading a response characteristic.

And in the second conventional technique shown by FIG. 3 and fourth conventional technique shown by FIG. 5, the digital AGC circuit 91 refers to a signal after a timing recovery and accordingly a gain control can be carried out at a symbol point (i.e., an ideal signal point), thereby enabling a high speed time response. However, there is a problem of double loops occurring, that is, an amplitude control loop by the digital AGC circuit 91 and that by the center tap of the automatic equalizer, thus resulting in the amplitude control becoming unstable.

And in the third conventional technique shown by FIG. 4, the A/D converter 85 performs a sampling at a clock after a timing recovery. However, the digital AGC loop is carried out by referring to a signal prior to equalization, thereby resulting in being greatly affected by an interference wave. In this case, first the control is such as to make a desired wave level small for example, followed by a signal processing in which the desired wave is amplified. That is, there is a problem of signal accuracy being degraded because the desired wave is amplified after being attenuated.

### SUMMARY OF THE INVENTION

A challenge of the present invention is to provide a demodulation circuit and a demodulation method which enable a circuit size compact.

Another challenge of the present invention is to provide a demodulation circuit and a demodulation method which enable a circuit size compact while securing an accuracy of an amplitude control.

A first demodulation circuit according to the present invention is the one for demodulating a signal, comprising: an automatic equalizer for carrying out equalization processing of a signal, and a carrier recovery circuit for carrying out a carrier recovery control from an equalized signal by the automatic equalizer, wherein a center tap for carrying out an amplitude control of the automatic equalizer is placed on an input side thereof, and a control signal to the center tap is transmitted from the automatic equalizer.

A second demodulation circuit according to the present invention is the one for demodulating a signal, comprising: an A/D converter for carrying out a signal point identification of a signal at a predetermined timing; an interpolator unit for correcting an identification timing relating to a signal which is signal-point identified by the A/D converter; and an automatic equalizer for equalizing a signal whose identification timing is corrected by the interpolator unit, wherein a center tap for carrying out an amplitude control of the automatic equalizer is placed on an input side of the interpolator unit, and a control signal to the center tap is transmitted from the automatic equalizer.

### BRIEF DESCRIPTION OF THE DRAWINGS

FIG. 1 is a block diagram showing a configuration of a QAM receiver (i.e., a QAM demodulation circuit) according to a first conventional technique;

FIG. 2 shows a further detail of a main part of the automatic equalizer unit shown by FIG. 1;

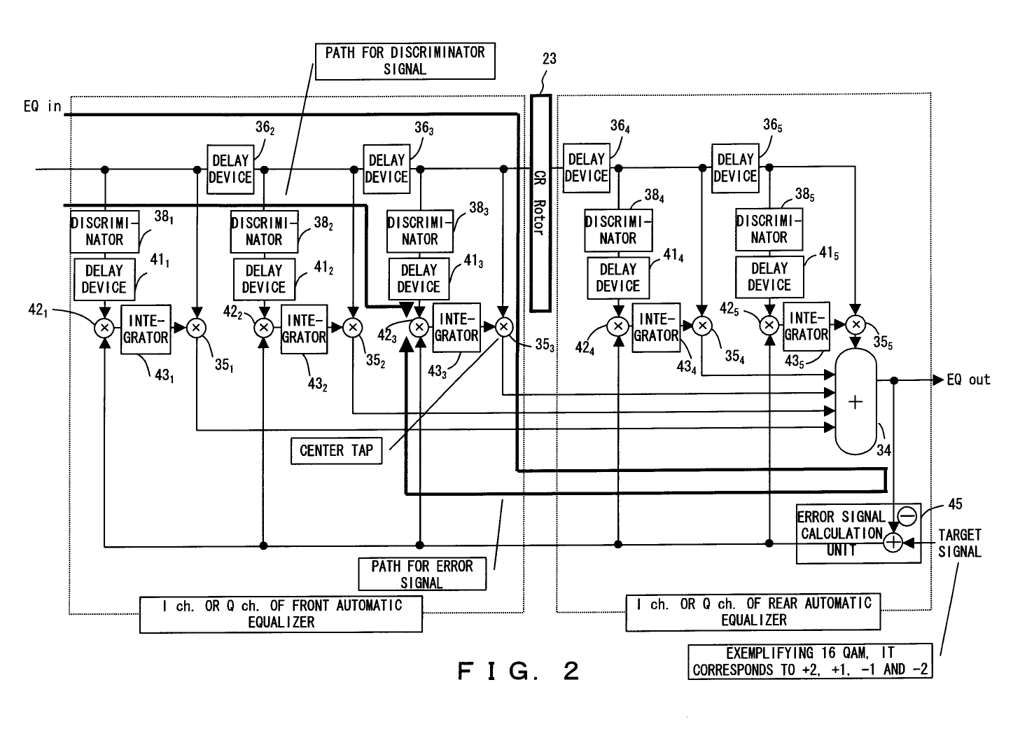

FIG. 3 is a block diagram showing a configuration of a QAM receiver (i.e., a QAM demodulation circuit) according to a second conventional technique;

FIG. 4 is a block diagram showing a configuration of a QAM receiver (i.e., a QAM demodulation circuit) according to a third conventional technique;

FIG. 5 is a block diagram showing a configuration of a QAM receiver (i.e., a QAM demodulation circuit) according to a fourth conventional technique;

FIG. 6 is a block diagram showing a configuration of a QAM receiver (i.e., a QAM demodulation circuit) according to an embodiment of the present invention;

FIG. 7A is an input waveform spectrum (part 1) of a channel selection filter;

FIG. 7B is an output waveform spectrum (part 1) of a channel selection filter;

FIG. 8A is an input waveform spectrum (part 2) of a channel selection filter;

FIG. 8B is an output waveform spectrum (part 2) of a channel selection filter;

FIG. 9 shows a further detail of a main part of the automatic equalizer unit shown by FIG. 6 (part 1);

FIG. 10 shows an eye pattern of a received signal;

FIG. 11 shows a further detail of a main part of the carrier recovery loop shown by FIG. 6;

FIG. 12 shows a further detail of a main part of the timing recovery loop shown by FIG. 6;

FIG. 13 shows a generated waveform and a referred clock at the timing recovery loop shown by FIG. 6, with (a) showing a waveform of a saw-tooth wave output from a numerical control oscillator (NCO), (b) showing a first clock (i.e., a sampling clock) and (c) showing a second clock (i.e., a thinned-out clock);

FIG. 14 shows a setup example of a tap coefficient for a tap table together with an impulse response;

FIG. 15 shows a further detail of a main part of the automatic equalizer unit shown by FIG. 6 (part 2); and

FIG. 16 is a block diagram showing a configuration of a modified example of a QAM receiver (i.e., a QAM demodulation circuit) according to the present embodiment.

### DESCRIPTION OF THE PREFERRED EMBODIMENTS

A demodulation circuit of a first aspect according to the present invention is the one for demodulating a signal, comprising: an automatic equalizer for carrying out equalization processing of a signal, and a carrier recovery circuit for carrying out a carrier recovery control from an equalized signal by the automatic equalizer, wherein a center tap for carrying out an amplitude control of the automatic equalizer is placed on an input side thereof, and a control signal to the center tap is transmitted from the automatic equalizer.

Here, a tap (i.e., a center tap) for controlling an amplitude of data of the current clock time at an automatic equalizer is placed on an input side thereof, and also a tap coefficient provided for the tap, that is, an amplitude of data of the current clock time, is output from the automatic equalizer so as to make signal equalization processing double function as a signal gain control also, thereby eliminating a digital AGC circuit and enabling a circuit size to be compact.

Meanwhile, in the case of a gain control (i.e., an amplitude control) loop double functioned by signal equalization processing of the present embodiment, since a signal from which an interference wave is removed (i.e., equalized) is used, the signal can be brought close to an ideal signal point. A range of data distribution is accordingly narrowed down so as to make it possible to maintain an accuracy of signal equalization processing and gain control processing (i.e., amplitude control processing) without particularly increasing the number of data points used for obtaining a temporal average at the automatic equalizer.

A demodulation circuit of a second aspect according to the present invention is the one for demodulating a signal, comprising: an A/D converter for carrying out a signal point identification of a signal at a predetermined timing; an interpolator unit for correcting an identification timing relating to a signal which is signal-point identified by the A/D converter; and an automatic equalizer for equalizing a signal whose identification timing is corrected by the interpolator unit, wherein a center tap for carrying out an amplitude control of the automatic equalizer is placed on an input side of the interpolator unit, and a control signal to the center tap is transmitted from the automatic equalizer.

Here, a tap (i.e., a center tap) for controlling an amplitude of data of the current clock time at an automatic equalizer is placed on an input side thereof, and also a tap coefficient provided for the tap, that is, the amplitude of the data of the current clock time, is output from the automatic equalizer, thereby controlling a gain of an input signal. By so doing, a signal equalization processing double functions as a signal gain control also and a digital AGC circuit is eliminated, thereby making a circuit size compact.

And the automatic equalizer carries out signal equalization processing by using data whose identification timing is corrected (i.e., timing-recovered data) by the interpolator unit. The timing-recovered data becomes the data lying to an ideal signal point, thereby resulting in obtaining a temporal average close to an ideal signal point. A range of the data input to the automatic equalizer in the up and down direction of a signal point is accordingly narrowed down so that it is possible to maintain an accuracy of signal equalization processing and gain control processing (i.e., amplitude control processing) without particularly increasing the number of data points used for obtaining a temporal average at the automatic equalizer.

A demodulation method of a third aspect according to the present invention is the one executed by a demodulation circuit for demodulating a received signal, comprising the steps of a signal equalization for removing an interference wave from a received modulated signal by using an automatic equalizer unit, and an amplitude control for outputting a tap coefficient, from the automatic equalizer unit to a tap, which is placed on an input side thereof, for carrying out an amplitude control of data of the current clock time at the automatic equalizer unit.

A demodulation method of a fourth aspect according to the present invention is the one executed by a demodulation circuit for demodulating a received signal, comprising the step of an interpolation for generating a value of data of a clock time displaced, by a length of time equivalent to a set phase angle, from a clock time at which the data has been sampled by interpolation by using an interpolation unit based on the set phase angle and the aforementioned data sampled from a modulated wave; the step for calculating a temporal increase or decrease of an output (that is, a timing error) from the automatic equalizer unit and setting the phase angle so as to eliminate the temporal increase or decrease (that is, a timing error); and the step of an amplitude control for outputting a tap coefficient, from the automatic equalizer unit to a tap, which is placed on an input side of the interpolator unit, for carrying out an amplitude control for data of the current clock time at the automatic equalizer unit.

The center tap coefficient is an equalization signal as a result of integrating the product of the current point signal and an error signal provided by the difference between the sum of taps other than the center tap and a target signal, and therefore has an equalization function. And the equalizer has also an AGC function as a result of inputting the center tap coefficient to an AGC-use multiplier.

What are eliminated in the circuit configuration according to the present invention, as compared to the conventional circuit configuration, are a digital AGC circuit, respective mixers installed on an output side thereof and a hardware volume of interpolators per se. As for the interpolators, a dynamic range is suppressed, thereby the number of bits as the subject of processing being reduced, resulting in a hardware volume of the interpolators per se being reduced.

The demodulation circuit according to the present invention comprises a gain control (i.e., an amplitude control) loop double functioned by signal equalization processing and therefore a problem associated with a demodulation circuit (e.g., a QAM modulation circuit) of a conventional technique for example ceases to occur.

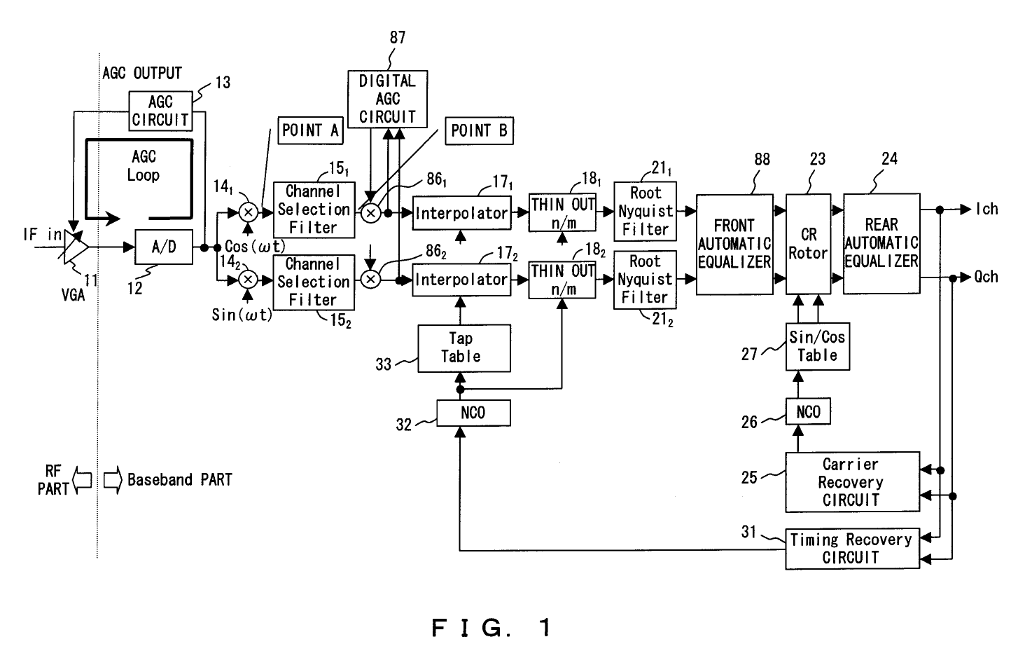

That is, as for the problem occurring in the digital AGC loop of the first conventional technique shown by FIG. 1, the case of the gain control (i.e., the amplitude control) loop double functioned by the signal equalization processing according to the present invention uses data lying to the signal point as a result of interpolation, thereby enabling the number of data points used for taking a temporal average to be reduced and a degradation of a response characteristic to be avoided.

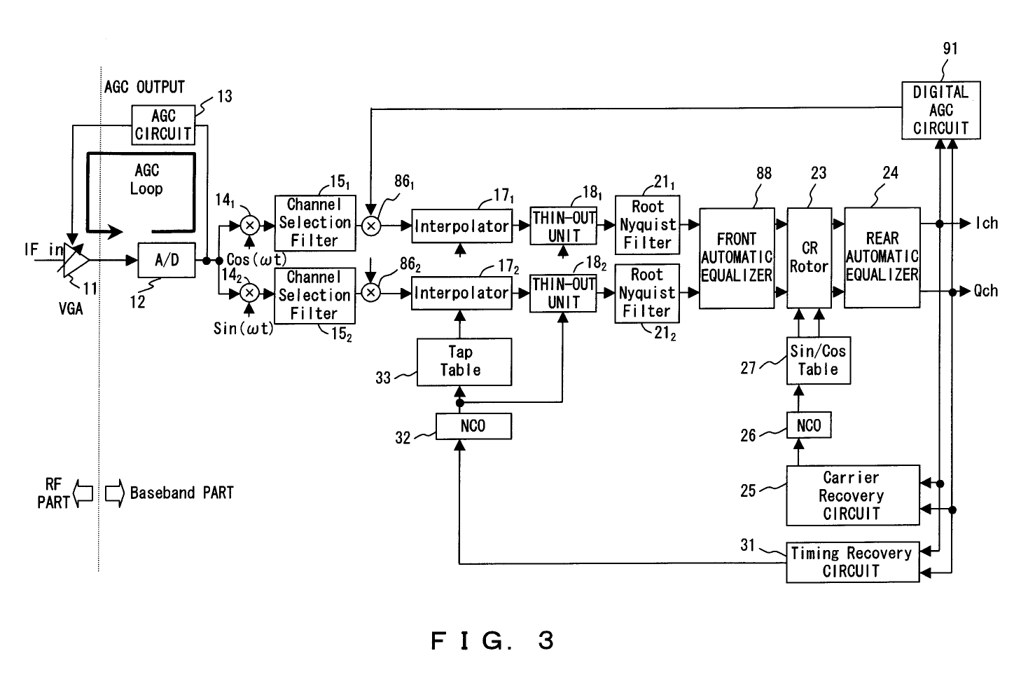

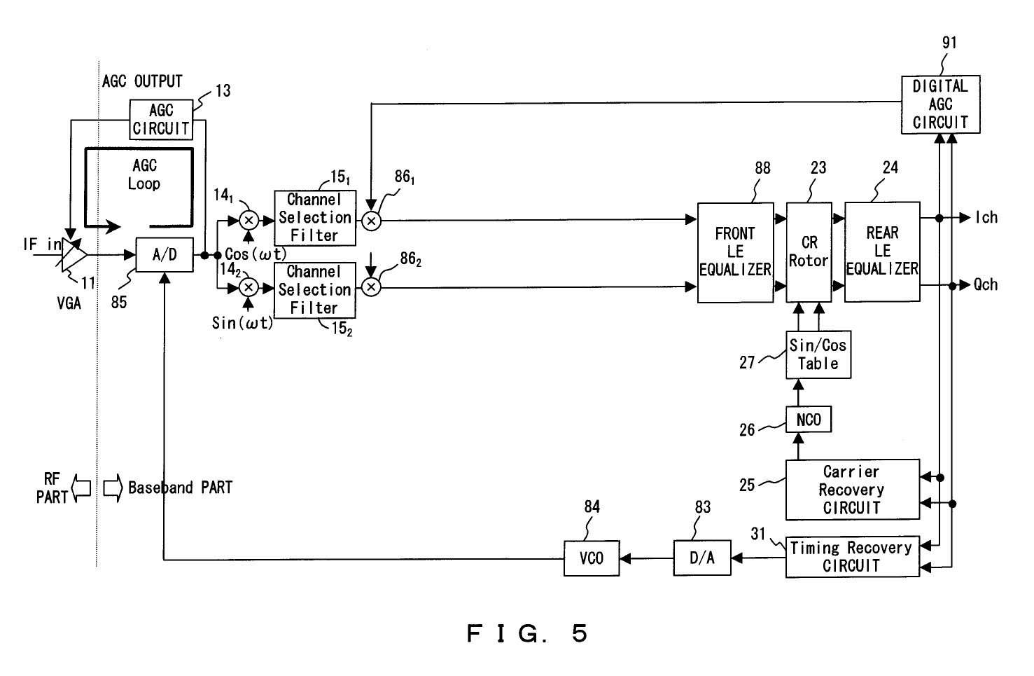

And, as for the problem occurring due to the amplitude control loop being dualized in the second conventional technique shown by FIG. 3 and the fourth conventional technique shown by FIG. 5, the case of the amplitude control loop according to the present invention does not allow such a problem to occur because it is integrated by the gain control (i.e., the amplitude control) loop which is double functioned by the signal equalization processing.

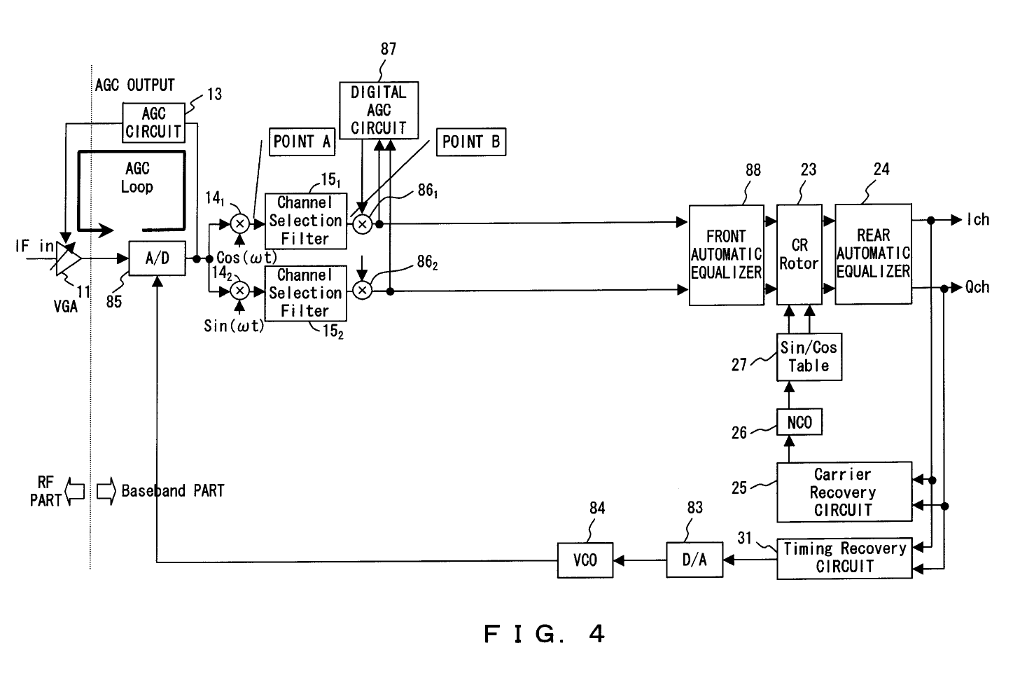

Also, as for problem of the degradation of the signal accuracy occurring in the digital AGC loop of the third conventional technique shown by FIG. 4, the case of the present invention greatly improves a degree of degradation of a signal because a gain control is carried out by using an equalized signal.

The following is a detailed description of the preferred embodiment of the present invention while referring to the accompanying drawings.

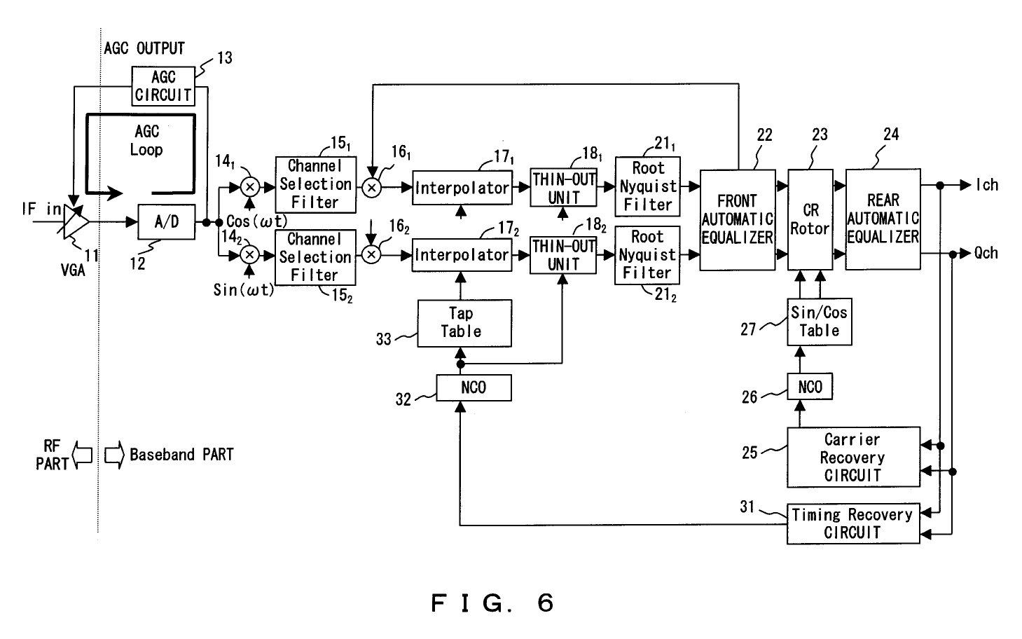

FIG. 6 is a block diagram showing a configuration of a QAM receiver (i.e., a QAM demodulation circuit) according to an embodiment of the present invention. Note that a sampling rate of the receiving side is set by two times or more of a symbol rate at the time of modulation on the transmission side.

Referring to FIG. 6, a tuned-in signal IFᵢₙ is input to a variable gain amplifier (VGA) 11 by a tuner (not shown herein) at the previous stage.

The signal IFᵢₙ is amplified by way of the VGA 11 and converted into the digital from analog by way of an A/D (analog to digital) converter 12.

The signal output from the A/D converter 12 is branched into a signal headed to an AGC circuit 13 and signals headed to mixers 14₁ and 14₂ (these mixers are also called I/Q separation circuits).

The output of the A/D converter 12 headed to the AGC circuit 13 is evaluated thereby for its power and outputs a gain control signal to the VGA 11. That is, a gain control loop (i.e., AGC loop) is constituted by the VGA 11, A/D converter 12 and AGC circuit 13. The gain control loop controls an output of the A/D converter 12 so as to make the power constant, and therefore it is also called a power control loop.

Meanwhile, the output of the A/D converter 12 headed to the mixers 14₁ and 14₂ is multiplied by mutually orthogonal Sine waves respectively indicated by Cos(ωt) and Sin(ωt) at the mixers 14₁ and 14₂, thereby being separated into the I channel and Q channel signals and also down-converted to a base band.

Channel selection filters (i.e., low pass filters) 15₁ and 15₂ respectively remove an upper signal generated by a down-conversion and also an adjacent channel (signal) of the signal.

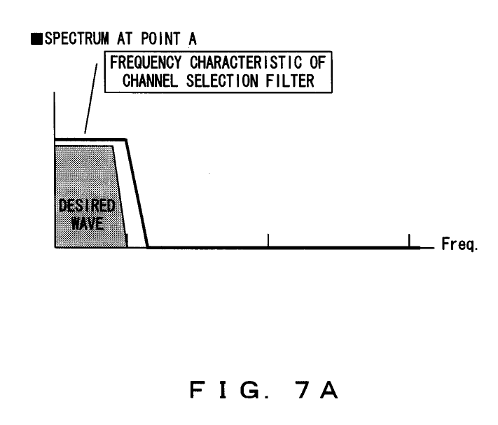

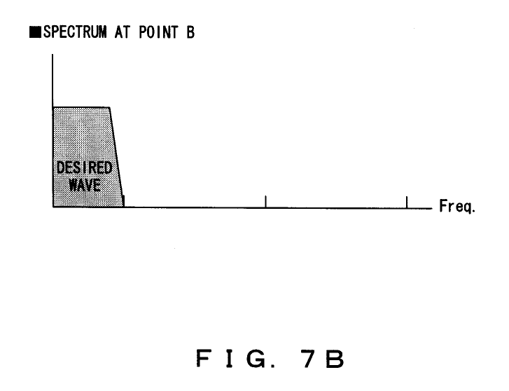

If a received signal does not contain a strong adjacent wave for instance, the spectrum as shown by FIG. 7A is gained as a spectrum of a wave input to a channel selection filter and also the spectrum as shown by FIG. 7B is gained as a spectrum of a wave output from the channel selection filter.

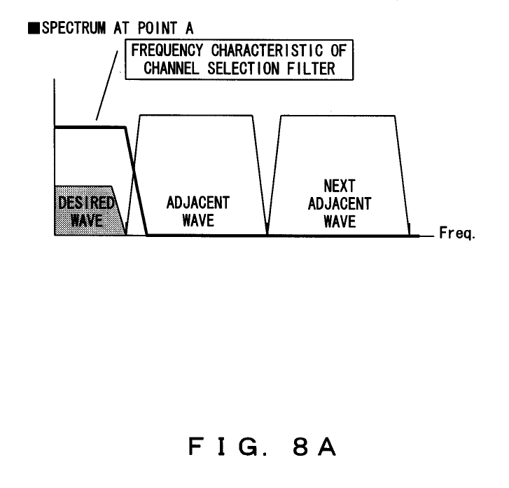

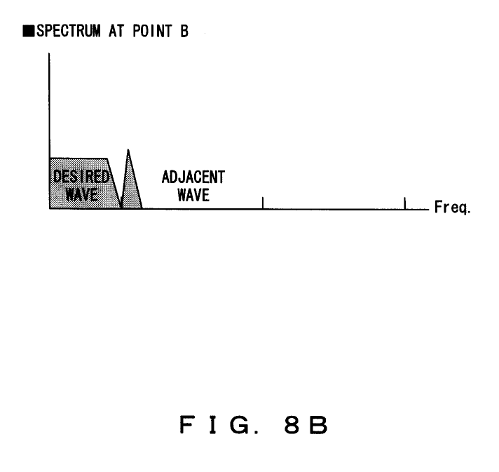

If a received signal contains a strong adjacent wave for instance, the spectrum as shown by FIG. 8A is gained as a spectrum of a wave input to a channel selection filter and also the spectrum as shown by FIG. 8B is gained as a spectrum of a wave output from the channel selection filter.

The outputs of the channel selection filters 15₁ and 15₂ are respectively input to mixers 16₁ and 16₂ and respectively multiplied by an output of a front automatic equalizer 22 at the mixers 16₁ and 16₂. Here, each of the mixers 16₁ and 16₂ is a tap, which is placed on an input side of each of interpolators 17₁ and 17₂, for controlling the amplitude of data of the current clock time at an automatic equalizer unit as described later.

The outputs of the mixers 16₁ and 16₂ are respectively input to the interpolators 17₁ and 17₂.

Each of the interpolators 17₁ and 17₂ generates a value of data at a clock time displaced from the clock time of input data by interpolation based on a tap coefficient received from a tap table 33 and input data. Thin-out units 18₁ and 18₂ respectively thin out duplicated points from the outputs of the interpolators 17₁ and 17₂.

The outputs of the thin-out units 18₁ and 18₂ are applied by a band limitation by way of Root Nyquist filters (i.e., low pass filters) 21₁ and 21₂, by which a white noise and an adjacent channel in the neighborhood are removed.

The output of the Root Nyquist filters 21₁ and 21₂ are input to the front automatic equalizer 22. An automatic equalizer unit is constituted by the front automatic equalizer 22, carrier recovery (CR) rotor 23 and rear automatic equalizer 24.

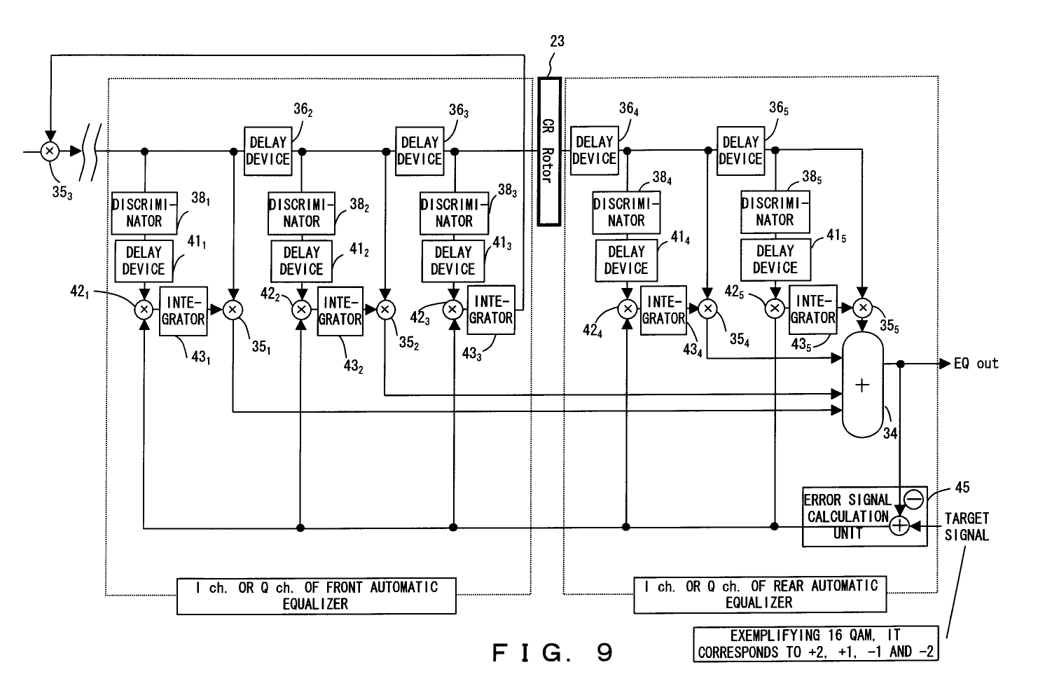

FIG. 9 shows a further detail of a main part of the automatic equalizer unit shown by FIG. 6 (part 1).

An I channel and Q channel are respectively equipped with a front automatic equalizer and a rear automatic equalizer, both shown by FIG. 9. An interference wave is removed from data of the current clock time by data equalization processing at the automatic equalizer unit. Note that the automatic equalizer unit shown by FIG. 9 is comprised by using an MZF (Modified Zero Forcing) method.

The automatic equalizer unit shown by FIG. 9 is an FIR filter with a tap coefficient operation function. Delay devices 36₂ through 36₅ indicate the ones for the FIR filter. Discriminators 38₁ through 38₅, delay devices 41₁ through 41₅, mixers 42₁ through 42₅, integrators 43₁ through 43₅ and error signal calculation unit 45 constitute a tap coefficient operation unit.

The automatic equalizer unit shown by FIG. 9 is the one of a five-stage configuration capable of setting five tap coefficients which are respectively set for mixers 35₁, 35₂, 35₃, 35₄, and 35₅. The mixer 35₃ is a tap (i.e., a center tap) for which a tap coefficient for data of the current clock time (i.e., a clock time t) is set, and is placed on an input side of the automatic equalizer unit. The mixer 35₁ is a tap for which a tap coefficient for data of the second newer clock time (i.e., the clock time t−2) than the current clock time is set. The mixer 35₂ is a tap for which a tap coefficient for data of the first newer clock time (i.e., the clock time t−1) than the current clock time is set. The mixer 35₄ is a tap for which a tap coefficient for data of the first older clock time (i.e., the clock time t+1) than the current clock time is set. The mixer 35₅ is a tap for which a tap coefficient for data of the second older clock time (i.e., the clock time t+2) than the current clock time is set.

The discriminators 38₁ through 38₅ are input by sampling data at corresponding respective clock times and calculate, and output, factors for multiplying by an error signal output from an error signal calculation unit 45 according to a sign (i.e., positive or negative) of the input sampling data (i.e., the data of the I channel or Q channel).

The factors output from the discriminators 38₁ through 38₅ are multiplied by an error signal from the error signal calculation unit 45 at the mixers 42₁ through 42₅. That is, the error signals considering signs of data at the corresponding respective clock times are output from the mixers 42₁ through 42₅. Note that the delay devices 41₁ through 41₅ read out outputs of the latched discriminators 38₁ through 38₅ to the mixers 42₁ through 42₅ so that the multiplication at the mixers 42₁ through 42₅ are carried out at the right timing.

The error signals output from the mixers 42₁ through 42₅ are respectively integrated at integrators 43₁ through 43₅ and tap coefficients at the respective clock times are obtained. The tap coefficient of the current clock time, that is, the output of the integrator 43₃, is output to the center tap (mixer) 35₃.

The output of the integrator 43₃, that is, a tap coefficient calculated from the data of the current clock time, is an amplitude of the data of the current clock time and therefore the tap coefficient is output to the center tap (i.e., the mixer) 35₃ placed on an input side of the interpolators 17₁ and 17₂, thereby enabling to comprise a gain control (i.e., an amplitude control) loop. Note that the gain control loop is constituted by the interpolators 17₁ and 17₂, thin-out units 18₁ and 18₂, Root Nyquist filters 21₁ and 21₂, and automatic equalizer unit.

Tap coefficients for clock times other than the current clock time, that is, the output of the integrators 43₁, 43₂, 43₄ and 43₅, are respectively multiplied by signals of the respectively corresponding clock times at the taps (i.e., the mixers) 35₁, 35₂, 35₄, and 35₅ of the respective clock times and output to the adder 34.

The adder 34 outputs a signal EQ_{OUT} by adding the outputs of the mixers (i.e., the taps) 35₁, 35₂, 35₄, and 35₅. The error signal calculation unit 45 acquires the difference between the signal EQ_{OUT} and a target signal (i.e., an I component or a Q component of the ideal signal point near to the data of the current clock time; in the case of 16 QAM, +2, +1, −1, and −2 make target signals for example), and outputs the differences as the error signals to the mixers 42₁ through 42₅. Note that the tap placed on an input side of the automatic equalizer unit is the one for carrying out an amplitude control of data of the current clock time. A center tap for outputting a fixed value may exist within the automatic equalizer unit.

As described above, the present embodiment is configured to place the tap (i.e., the center tap) for controlling the amplitude of data of the current clock time at the automatic equalizer unit on an input side thereof and also output the tap coefficient provided for the center tap, that is, the amplitude of the data of the current clock time from the automatic equalizer unit, thereby making a signal equalization processing double function as a signal gain control also, and eliminating a digital AGC circuit, resulting in making a circuit size compact.

The configuration shown by FIG. 6 is such that the input sides of the interpolators 17₁ and 17₂ are equipped with the center taps (i.e., the mixers) 16₁ and 16₂ which control amplitudes of data of the current clock time in the automatic equalizer unit. This enables a dynamic range of inputs to the interpolators 17₁ and 17₂ to be suppressed and a circuit size to be compact as a result of suppressing the number of bits for such as a built-in mixer, et cetera.

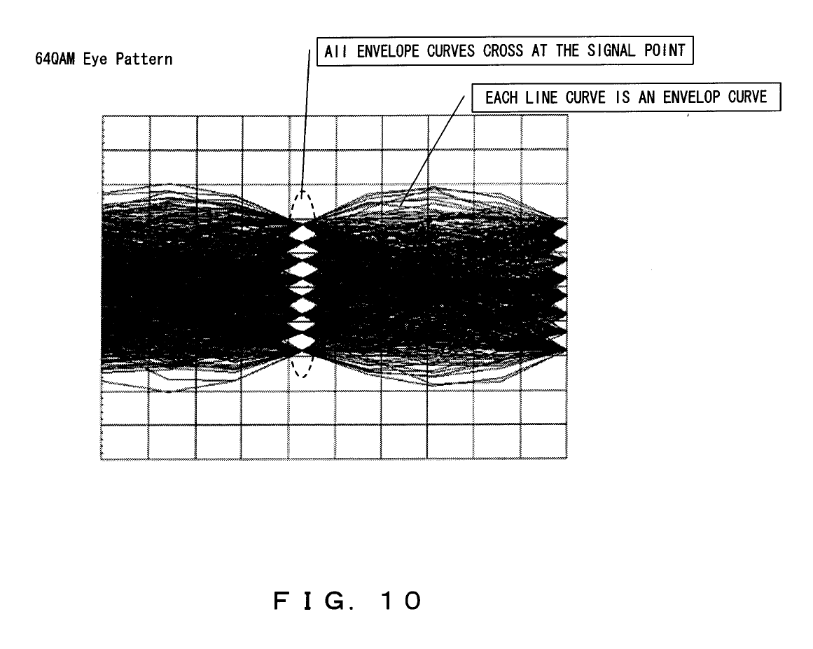

The present embodiment is also configured to carry out a signal equalization processing by using interpolated data (i.e., timing-recovered data). Because the interpolated data (i.e., the timing-recovered data) is the one lying to an ideal signal point, a temporal average is taken in the neighborhood of an ideal signal point. And because loci of the respective envelope curves constituting an eye pattern passes the neighborhood of an ideal signal point, a window shape is formed in the neighborhood of the signal point as shown by FIG. 10. This then narrows down a range of signal points of data which are input to the automatic equalizer unit in the up and down direction, thus enabling an accuracy of the signal equalization processing and gain control processing (i.e., the amplitude control processing) to be maintained without particularly increasing the number of data points used for taking a temporal average.

In a QAM demodulation circuit, signal points are lined up on an IQ plane in close intervals, and therefore high accuracies are required for interpolation processing performed at the interpolators 17₁ and 17₂ and operation processing performed at the rear stage thereof. For example, although there is a problem in which the number of bits of mixers constituting an interpolator and the number of output bits of the carrier recovery circuit 25 and timing recovery circuit 31 increase, resulting in a circuit size becoming large, the dynamic ranges of inputs to the interpolators 17₁ and 17₂ are suppressed so as to suppress the number of bits of mixers of the interpolators 17₁ and 17₂ and that of bits of the output of the carrier recovery circuit 25 and timing recovery circuit 31 as described above, thereby making it possible to make a circuit size further compact.

Once again, the description of FIG. 6 is resumed.

The signal equalized after an interference wave thereof is removed, that is, the output of the rear automatic equalizer 24 is branched into a signal progressing to a later stage, one headed to the carrier recovery circuit 25 and one headed to the timing recovery circuit 31.

The carrier recovery circuit 25 calculates a displacement of a phase, on an IQ phase plane, between a signal of the current clock time and an ideal signal point close to the aforementioned signal based on the output of the rear automatic equalizer 24 and outputs a value reflected by the phase displacement to the numerical controlled oscillator (NCO) 26. The NCO 26 generates a saw-tooth wave with the amplitude of a value reflected by the phase displacement and outputs it to a Sin/Cos table 27. The Sin/Cos table 27 maps the amplitude of the input saw-tooth wave to one cycle of the phase angle (−π to π) and calculates values of a sine and a cosine relative to the phase angle corresponding to the amplitude of the input saw-tooth wave. The calculated sine and cosine values are output to the carrier recovery rotor 23 which then uses the calculated sine and cosine values, and applies a primary conversion, thereby rotating the signal of the current clock time on the IQ phase plane. Note that the rear automatic equalizer shown by FIG. 9 uses the data processed for rotation by the carrier recovery rotor 23 as the data of each clock time, as is apparent by way of the above description.

Meanwhile, the timing recovery circuit 31 calculates a temporal increase or decrease (i.e., a timing error) of a signal nearby a signal of the current clock time based on the output of the rear automatic equalizer 24, and outputs a value reflected by the temporal increase or decrease (i.e., the timing error) of the signal to a numerical control oscillator (NCO) 32. The NCO 32 generates a saw-tooth wave having the amplitude of the value reflected by the temporal increase or decrease (i.e., a timing error) of the signal. The saw-tooth wave generated by the NCO 32 is output to the tap table 33 and thin-out units 18₁ and 18₂. The tap table 33 maps the amplitude of the input saw-tooth wave in one cycle of the phase angle (−π to π) and calculates (a plurality of) tap coefficients of phase angles Δθ corresponding to the amplitude of the input saw-tooth wave.

The calculated tap coefficients are output to the interpolators (i.e., FIR filters) 17₁ and 17₂ which then generates values of data at a displaced time from the clock time of the input data by interpolation based on the input (plurality of) tap coefficients from the tap table 33 and the input data. The output of the interpolators 17₁ and 17₂ are respectively input to the thin-out units 18₁ and 18₂.

The thin-out units 18₁ and 18₂ generate thinned-out clocks based on the saw-tooth wave from the NCO 32 and read out data latched by the thinned-out clocks to later stages, thereby thinning out duplicated points from the signals transmitted from the interpolators 17₁ and 17₂.

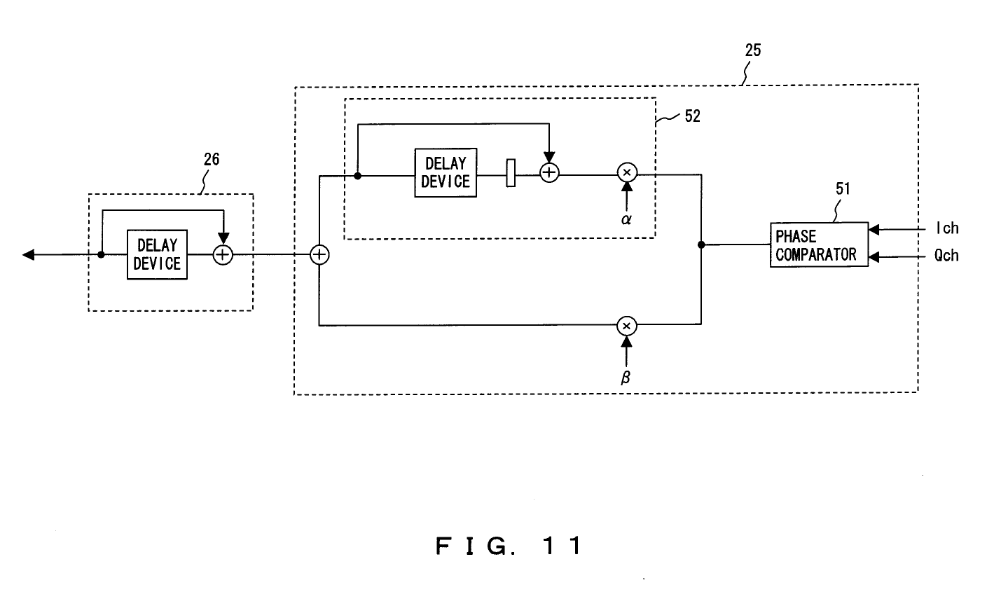

FIG. 11 shows a further detail of a main part of the carrier recovery loop shown by FIG. 6.

As shown by FIG. 11, the carrier recovery circuit 25 comprises a phase comparator 51 for calculating a displacement of a phase on an IQ plane based on a signal of the current clock time (i.e., signals in I channel and Q channel) and an ideal signal point close to the signal (the I component and Q component of the signal) of the current clock time, an integrator 52 for calculating an offset value by multiplying an output of the phase comparator 51 by a constant (α) followed by integrating it, and also a loop filter for outputting a value which is the offset value plus an output of the phase comparator multiplied by a constant (β) (i.e., the offset value+β×(the output of the phase comparator)) to the numerical controlled oscillator (NCO) 26.

The numerical controlled oscillator (NCO) 26 comprises a delay device and an adder. An output of a loop filter after a sufficient length of time elapsing becomes approximately constant. Because of this, the NCO 26 outputs a saw-tooth wave obtained by adding or subtracting an approximately constant value at each timing in the case of a sufficient length of time elapsing.

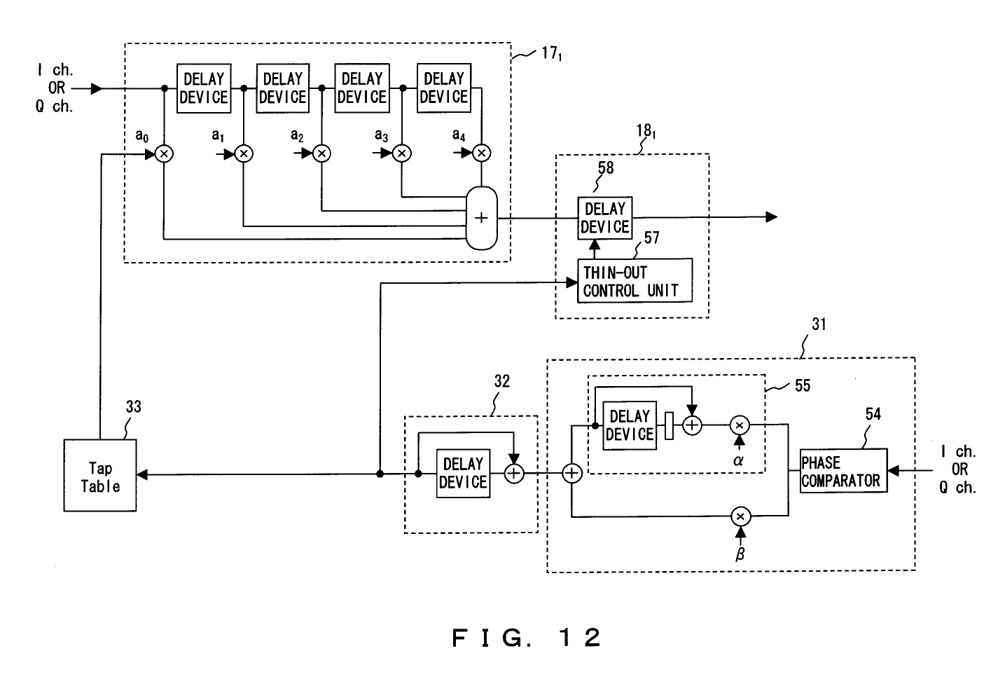

FIG. 12 shows a further detail of a main part of the timing recovery loop shown by FIG. 6. Note that FIG. 12 shows a circuit corresponding to a signal of the I channel and that a signal of the Q channel is separately equipped with the same circuit.

As shown by FIG. 12, the timing recovery circuit 31 comprises a phase comparator 54 for calculating an increase or decrease in the neighborhood of a signal of the current clock time (i.e., a timing error), an integrator 55 for calculating an offset value by multiplying an output of the phase comparator 54 by a constant (α) followed by integrating it, and also a loop filter for outputting a value which is the offset value plus an output of the phase comparator multiplied by a constant (β) (i.e., the offset value+β×(the output of the phase comparator)) to a numerical controlled oscillator.

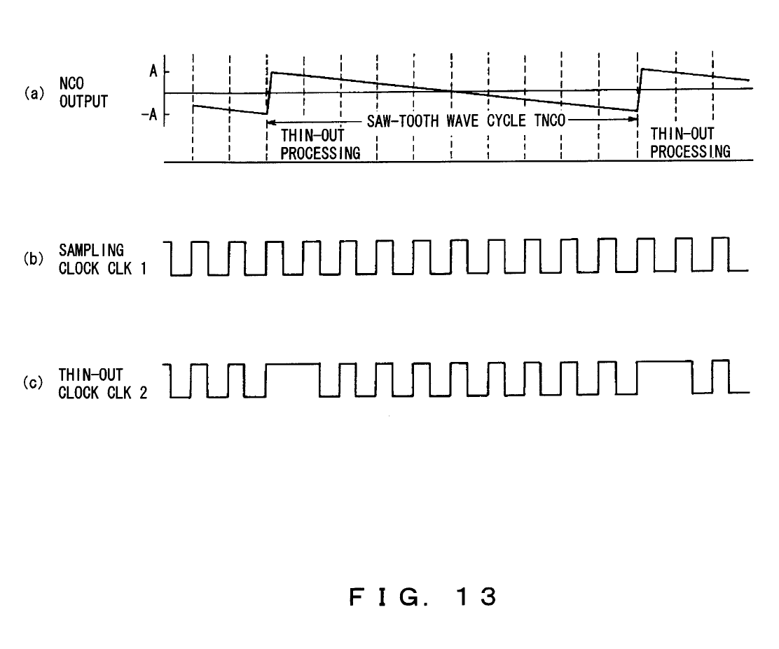

The numerical controlled oscillator (NCO) 32 comprises a delay device and an adder. An output of a loop filter after a sufficient length of time elapsing becomes approximately constant. Because of this, the NCO 32 outputs a saw-tooth wave obtained by adding or subtracting an approximately constant value at each timing in the case of a sufficient length of time elapsing. FIG. 13 (a) shows an example of a saw-tooth wave output from the NCO 32. This example shows the shape of the saw-tooth wave slanting toward the right because the output of the phase comparator 54 is a negative value.

The output of the NCO 32 is headed to the tap table 33 or the thin-out unit 18₁.

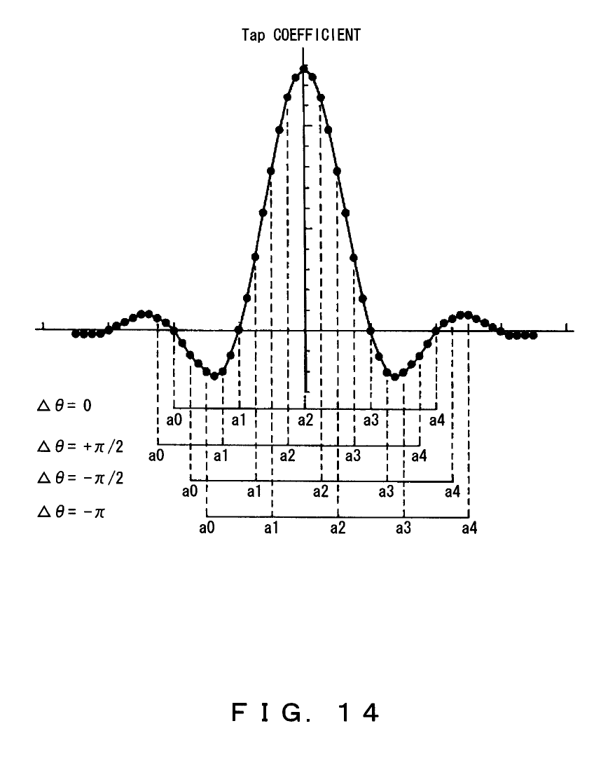

The tap table 33 maps the amplitude of the input saw-tooth wave in one cycle of the phase angle (−π to π) and calculates (a plurality of) tap coefficients of phase angles Δθ corresponding to the amplitude of the input saw-tooth wave as described above. FIG. 14 shows a setup tap coefficient, together with an impulse response, so that an interpolator comprises an All Pass Filter in the case of a phase difference being zero.

Tap coefficients a0, a1, a2, a3 and a4 which are output from the tap table 33 are input to the interpolator 17₁ for carrying out a symbol interpolation.

A thin-out control unit 57 within the thin-out unit 18₁ generates a thinned-out clock (i.e., a second clock) corresponding to the first clock based on the saw-tooth wave from the NCO 32 and a first clock (i.e., a sampling clock) from a clock generation unit (not shown herein), and outputs it to a delay device 58. The delay device 58 latches the output of the interpolator 17₁ and reads out the aforementioned output by the second clock, thereby thinning out duplicated points from the output of the interpolator 17₁.

FIG. 13 (b) shows the first clock CLK 1, and FIG. 13 (c) shows the second clock CLK 2. For example, the A/D converter 12, AGC circuit 13, channel selection filters 15₁ and 15₂, interpolators 17₁ and 17₂, NCO 32, tap table 33, which are all shown by FIG. 6, are operated by the first clock, while the thin-out units 18₁ and 18₂, Root Nyquist filters 21₁ and 21₂, front automatic equalizer 22, carrier recovery rotor 23, rear automatic equalizer 24, carrier recovery circuit 25, NCO 26, Sin/Cos table 27 and timing recovery circuit 31 are operated by the second clock.

The automatic equalizer unit is conceivably be configured to be other than the one shown by FIG. 9.

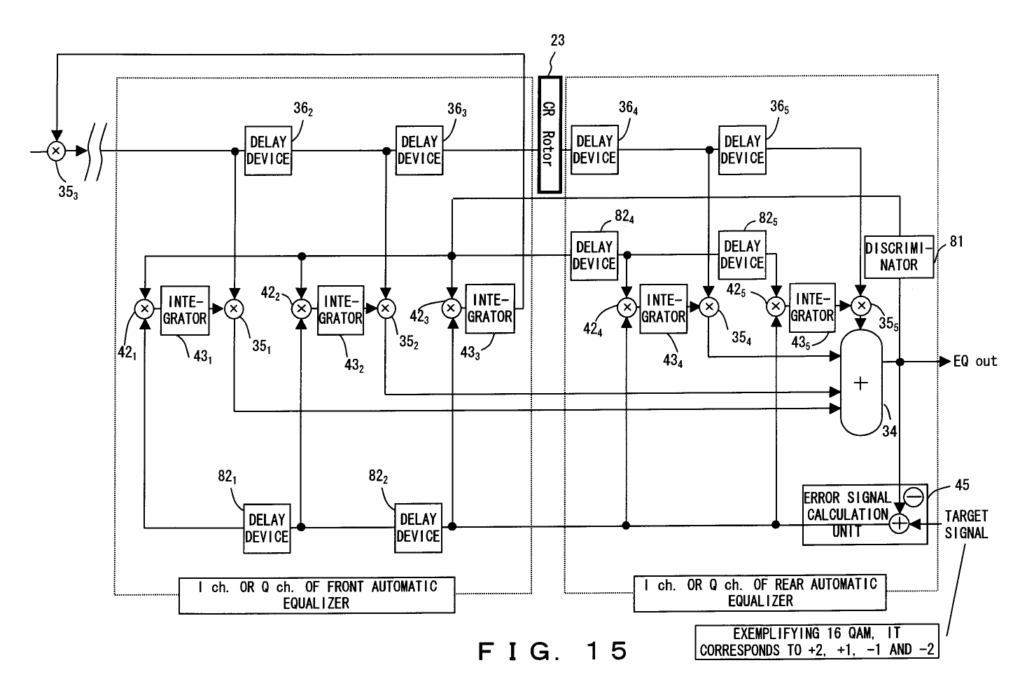

FIG. 15 shows a further detail of a main part of the automatic equalizer unit (part 2). The I channel and Q channel are respectively equipped with the front automatic equalizer and rear automatic equalizer which are shown by FIG. 15. Note that the automatic equalizer unit shown by FIG. 15 is comprised by using ZF (zero forcing) method.

The automatic equalizer unit shown by FIG. 15 is an FIR filter with a tap coefficient operation function. Delay devices 36₂ through 36₅ show the ones for the FIR filter. Discriminator 81, delay devices 82₁, 82₂, 82₄ and 82₅, mixers 42₁ through 42₅, integrators 43₁ through 43₅, and error signal calculation unit 45 constitute a tap coefficient operation unit.

The automatic equalizer unit shown by FIG. 15 is the one of a five-stage configuration capable of setting five tap coefficients. These five tap coefficients are respectively set for mixers 35₁, 35₂, 35₃, 35₄, and 35₅. The mixer 35₃ is a tap (i.e., a center tap) for which a tap coefficient for data of the current clock time (i.e., a clock time t) is set, and is placed on an input side of the automatic equalizer unit. The mixer 35₁ is a tap for which a tap coefficient for data of the second newer clock time (i.e., the clock time t−2) than the current clock time is set. The mixer 35₂ is a tap for which a tap coefficient for data of the first newer clock time (i.e., the clock time t−1) than the current clock time is set. The mixer 35₄ is a tap for which a tap coefficient for data of the first older clock time (i.e., the clock time t+1) than the current clock time is set. The mixer 35₅ is a tap for which a tap coefficient for data of the second older clock time (i.e., the clock time t+2) than the current clock time is set.

The discriminator 81 is input by the output EQ_{OUT} of the adder 34 and calculates, and outputs, a factor for multiplying an error signal output from the error signal calculation unit 45 according to a sign (i.e., positive or negative) of the input EQ_{OUT} (i.e., an added value of data of the I channel or Q channel).

The factor output from the discriminator 81 is multiplied by an error signal from the error signal calculation unit 45 at the mixers 42₁ through 42₅. That is, error signals considering signs of data at the corresponding respective clock times are output from the mixers 42₁ through 42₅. The delay devices 82₁ and 82₂ make error signals delay. Because of this, a factor output from the discriminator 81 at the current clock time and an error signal of the second older clock time (i.e., the clock time t+2) are multiplied at the mixer 42₁. And a factor output from the discriminator 81 at the current clock time and an error signal of the first older clock time (i.e., the clock time t+1) are multiplied at the mixer 42₂.

And the delay devices 82₄ and 82₅ make an output of the discriminator 81 delay. Because of this, a factor output from the discriminator 81 at the first older clock time (i.e., t+1) and an error signal at the current clock time (i.e., the clock time t) are multiplied at the mixer 42₄. And a factor output from the discriminator 81 at the second older clock time (i.e., the clock time t+2) and an error signal at the current clock time (i.e., the clock time t) are multiplied at the mixer 42₅.

The error signals output from the mixers 42₁ through 42₅ are respectively integrated by the integrators 43₁ through 43₅ to obtain tap coefficients for the respective clock times. The tap coefficient for the current clock time, that is, the output of the integrators 43₃, is output to the center tap (i.e., the mixer) 35₃ placed on an input side of the automatic equalizer unit.

The output of the integrator 43₃, that is, the tap coefficients calculated from the data of the current clock time, is the amplitude of the data of the current clock time. Therefore, outputting the tap coefficient to the center tap (i.e., the mixer) 35₃ placed on an input side of the interpolators 17₁ and 17₂ for example, enables to comprise a gain control (i.e., an amplitude control) loop. Note that the gain control loop is constituted by the interpolators 17₁ and 17₂, thin-out units 18₁ and 18₂, Root Nyquist filters 21₁ and 21₂, and an automatic equalizer unit.

The tap coefficients for clock times other than the current clock time, that is, the outputs of the integrators 43₁, 43₂, 43₄ and 43₅ are multiplied by the signals of the respectively corresponding clock times at the taps (i.e., the mixers) 35₁, 35₂, 35₄ and 35₅ of the respective clock times, and then output to the adder 34.

The adder 34 outputs a signal EQ_{OUT} which is an addition of the outputs of the mixers (i.e., the taps) 35₁, 35₂, 35₄ and 35₅. The error signal calculation unit 45 acquires the difference between the signal EQ_{OUT} and a target signal (i.e., an I component or a Q component of the ideal signal point near to the data of the current clock; in the case of 16 QAM, +2, +1, −1, −2 make target signals for example), and outputs the difference as the error signal to the mixers 42₁ through 42₅. Note that the tap placed on an input side of the automatic equalizer unit is the one for carrying out an amplitude control of data of the current clock time. A center tap for outputting a fixed value may exist within the automatic equalizer unit.

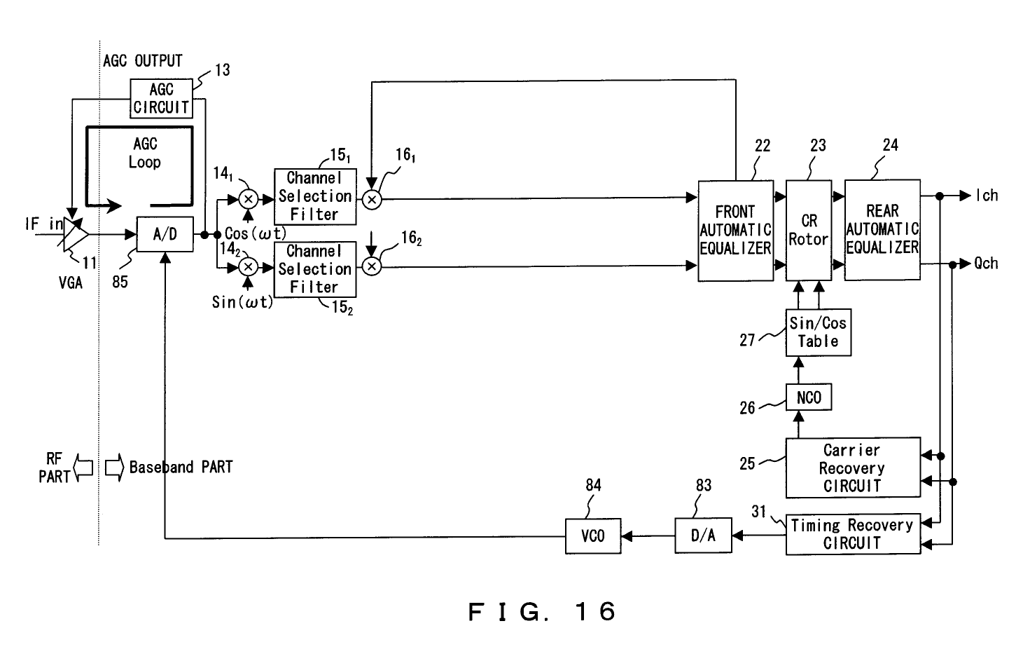

Note that it is also possible to convert a data sampling timing by an A/D converter 85 by feeding back an output of the timing recovery circuit 31 as shown by FIG. 16. In such a case, a D/A converter 83 for converting an output of the timing recovery circuit 31 from the digital to analog and a voltage controlled oscillator (VCO) 84 for outputting, to the A/D converter 85, a frequency corresponding to an output, which has been converted to analog, of the timing recovery circuit 31 are inserted between the timing recovery circuit 31 and A/D converter 85 for example as shown by FIG. 16.

And it is generally necessary to maintain an average of input levels (i.e., amplitudes) for carrying out a demodulation in all modulation system. Because of this, the present invention is applicable to all modulation systems (e.g., QAM modulation system, QPSK (quadrature phase shift keying modulation) system, et cetera).

What is claimed is:

1. A demodulation circuit for demodulating a signal, comprising:
an automatic equalizer for carrying out equalization processing of a signal, and
a carrier recovery circuit for carrying out a carrier recovery control from an equalized signal by the automatic equalizer, wherein
a center tap for carrying out an amplitude control of the automatic equalizer is placed on an input side thereof, and
a control signal to the center tap is transmitted from the automatic equalizer.

2. A demodulation circuit for demodulating a signal, comprising:
a signal processing unit for carrying out signal processing of a signal;
an automatic equalizer for equalizing a signal which is signal-processed by the signal processing unit; and
a carrier recovery circuit for carrying out a carrier recovery control from an equalized signal by the automatic equalizer, wherein
a center tap for carrying out an amplitude control of the automatic equalizer is placed on an input side of the signal processing unit, and
a control signal to the center tap is transmitted from the automatic equalizer.

3. A demodulation circuit for demodulating a signal, comprising
an automatic equalizer comprising a front equalizer and a rear equalizer which carry out equalization processing of a signal, and a carrier recovery circuit existing between the front equalizer and rear equalizer, wherein
a center tap for carrying out an amplitude control of the automatic equalizer is placed on an input side thereof, and
a control signal to the center tap is transmitted from the front equalizer and also a control signal to the carrier recovery circuit is created from an output signal of the rear equalizer.

4. A demodulation circuit for demodulating a signal, comprising
a signal processing unit for carrying out signal processing of a signal; and
an automatic equalizer comprising a front equalizer and a rear equalizer which carry out equalization processing of a signal which is signal-processed by the signal processing unit, and a carrier recovery circuit existing between the front equalizer and rear equalizer, wherein
a center tap for carrying out an amplitude control of the automatic equalizer is placed on an input side of the signal processing unit, and
a control signal to the center tap is transmitted from the front equalizer and also a control signal to the carrier recovery circuit is created from an output signal of the rear equalizer.

5. A demodulation circuit for demodulating a signal, comprising:
an A/D converter for carrying out a signal point identification of a signal at a predetermined timing;
an interpolator unit for correcting an identification timing relating to a signal which is signal point-identified by the A/D converter; and
an automatic equalizer for equalizing a signal whose identification timing is corrected by the interpolator unit, wherein
a center tap for carrying out an amplitude control of the automatic equalizer is placed on an input side of the interpolator unit, and
a control signal to the center tap is transmitted from the automatic equalizer.

6. A demodulation circuit for demodulating a signal, comprising:
an A/D converter for carrying out a signal point identification of a signal at a predetermined timing;
an interpolator unit for correcting an identification timing relating to a signal which is signal point-identified by the A/D converter; and
an automatic equalizer comprising a front equalizer and a rear equalizer which carry out equalization processing of a signal whose identification timing is corrected by the interpolator unit and a carrier recovery circuit existing between the front equalizer and rear equalizer, wherein
a center tap for carrying out an amplitude control of the automatic equalizer is placed on an input side of the interpolator unit, and
a control signal to the center tap is transmitted from the automatic equalizer.

7. A demodulation circuit for demodulating a received signal, comprising:
a reception unit for receiving a modulated signal; and
an automatic equalizer unit for removing an interference wave from a received modulated signal, wherein
a tap for carrying out an amplitude control of data of the current clock time at the automatic equalizer unit is placed on an input side thereof, and
a tap coefficient provided for a tap of the amplitude control is output from the automatic equalizer unit.

8. The demodulation circuit according to claim 7, wherein
said automatic equalizer unit comprises a first automatic equalizer, a second automatic equalizer and a carrier recovery circuit placed between the first and second automatic equalizers,
a tap at the automatic equalizer unit for carrying out an amplitude control of data of the current clock time is placed on the input side of the first automatic equalizer, and
the carrier recovery circuit calculates a displacement between an output of the second automatic equalizer and an ideal signal point on an IQ phase plane and recovers a carrier wave by rotating the output of the second automatic equalizer so as to eliminate the aforementioned displacement.

9. A demodulation circuit for demodulating a received signal, comprising:
a reception unit for receiving a modulated signal;
an interpolator unit for generating a value of data of a clock time displaced, by a length of time of a set phase angle, from the clock time at which the data has been sampled by interpolation, based on the set phase angle and the aforementioned data sampled from the modulated signal;
an automatic equalizer unit for removing an interference wave from the interpolated data; and
a timing recovery unit for calculating a temporal increase or decrease of an output (that is, a timing error) of the automatic equalizer and setting the phase angle so as to eliminate the temporal increase or decrease (that is, the timing error), wherein
a tap at the automatic equalizer unit for carrying out an amplitude control of data of the current clock time is placed on an input side of the interpolator unit, and
a tap coefficient provided for the tap for the amplitude control is output from the automatic equalizer unit.

10. A signal processing circuit for processing a signal
comprising an automatic equalizer unit for removing an interference wave from the signal,
placing a tap for carrying out an amplitude control of data of the current clock time at the automatic equalizer unit is placed on an input side of the automatic equalizer unit, and
further comprising an amplitude control loop for outputting, from the automatic equalizer unit to its center tap, a tap coefficient provided for a tap for controlling an amplitude at the automatic equalizer unit.

11. A demodulation method executed by a demodulation circuit for demodulating a received signal, comprising the steps of
a signal equalization for removing an interference wave from a received modulated signal by using an automatic equalizer unit, and
an amplitude control for outputting a tap coefficient, from the automatic equalizer unit to a tap, which is placed on an input side thereof, for carrying out an amplitude control of data of the current clock time at the automatic equalizer unit.

12. A demodulation method executed by a demodulation circuit for demodulating a received signal, comprising the steps of
an interpolation for generating a value of data of a clock time displaced, by a length of time equivalent to a set phase angle, from a clock time at which the data has been sampled by interpolation based on the set phase angle and the aforementioned data sampled from a modulated wave by using an interpolation unit;
a signal equalization for removing an interference wave from the interpolated data by using an automatic equalizer unit;
calculating a temporal increase or decrease of an output (that is, a timing error) from the automatic equalizer unit and setting the phase angle so as to eliminate the temporal increase or decrease (that is, a timing error); and
an amplitude control for outputting a tap coefficient from the automatic equalizer unit to a tap, which is placed on an input side of the interpolator unit, for carrying out an amplitude control for data of the current clock time at the automatic equalizer unit.

13. A signal processing method carried out by a signal processing circuit processing a signal, comprising the steps of
a signal equalization for removing an interference wave from the signal by using an automatic equalizer unit, and
an amplitude control for outputting a tap coefficient, from the automatic equalizer unit to a tap, which is placed on an input side thereof, for carrying out an amplitude control of data of the current clock time at the automatic equalizer unit.
